(19) United States
(12) Patent Application Publication
(10) Pub. No.: US 2018/0315995 A1
(43) Pub. Date: Nov. 1, 2018

(54) METHOD FOR MANUFACTURING AN ACCUMULATOR OF THE LITHIUM-ION TYPE

(71) Applicant: RENAULT, Boulogne Billancourt (FR)

(72) Inventors: Yvan REYNIER, Saint Egreve (FR); Mohamed CHAKIR, Saint-Germain-Les-Arpajon (FR); Bruno DELOBEL, Paris (FR); Florence MASSE, Grenoble (FR)

(73) Assignee: RENAULT, Boulogne Billancourt (FR)

(21) Appl. No.: 15/770,042

(22) PCT Filed: Oct. 19, 2016
(86) PCT No.: PCT/EP2016/075114

§ 371 Date: Apr. 20, 2018

(30) Foreign Application Priority Data
Oct. 21, 2015 (FR) 1560050

(51) Int. Cl. H01M 4/04; H01M 10/0525; H01M 10/058; H01M 4/58; H01M 4/36; H01M 4/587; H01M 4/40; H01M 4/485; H01M 4/38

(52) U.S. Cl. CPC H01M 4/0447; H01M 10/0525; H01M 10/058; H01M 4/5825; H01M 4/366; H01M 4/587; H01M 4/405; H01M 4/485; H01M 4/382; H01M 4/364

(57) ABSTRACT

The invention deals with a method of preparing a lithium-ion accumulator comprising a positive electrode and a negative electrode which are disposed on either side of an electrolyte, the positive electrode comprising, as active material, a lithium-based material, a method comprising the following steps: a) a step of depositing lithium salt on the surface of the positive electrode, before placement in the accumulator; b) a step of assembling the positive electrode, the negative electrode and the electrolyte; and c) a step of forming a passivation layer on the surface of the negative electrode with the lithium ions arising from the decomposition of the lithium salt by applying a first charge to the abovementioned assembly.

### TECHNICAL FIELD

This invention relates to a method for manufacturing an accumulator of the lithium-ion type.

The accumulators of this type are intended to be used as an autonomous source of energy, in particular, in portable electronic equipment (such as mobile telephones, portable computers, tools), in order to progressively replace nickel-cadmium (NiCd) and nickel-metal hydride (NiMH) accumulators. They can also be used to provide the supply with energy required for the new microapplications, such as chip cards, sensors or other electromechanical systems.

With regards to the operation thereof, accumulators of the lithium-ion type operate according to the principle of insertion-disinsertion of the lithium ion according to the following particulars.

During the discharging of the accumulator, the lithium disinserted from the negative electrode in the form of ionic Li⁺ migrates through the ionically conducting electrolyte and is inserted into the crystalline network of the active material of the positive electrode. The passage of each ion Li⁺ in the internal circuit of the accumulator is exactly offset by the passage of an electron in the external circuit, generating as such an electric current.

On the other hand, during the charging of the accumulator, the reactions that take place in the accumulator are the inverse reactions of discharging, namely:
the negative electrode will insert lithium into the network of the insertion material that comprises it;
the positive electrode will release lithium, which will be inserted into the insertion material of the negative electrode.

During the first charge cycle of the accumulator, when the active material of the negative electrode is brought to an insertion potential of the lithium, a portion of the lithium will react with the electrolyte on the surface of the grains of active material of the negative electrode in order to form a passivation layer on the surface thereof. The formation of this passivation layer consumes a non-negligible quantity of lithium ions, which is materialised by an irreversible loss in the capacity of the accumulator (this loss being qualified as irreversible capacity and able to be assessed at about from 5 to 20% of the initial capacity of the positive electrode), due to the fact that the lithium ions that have reacted are no longer available for later charging/discharging cycles.

This loss should then be minimised as much as possible during the first charge, so that the energy density of the accumulator is as high as possible.

To do this, it has been proposed, in prior art, two types of techniques in order to overcome the aforementioned disadvantages:
prelithiation techniques of the negative electrode; or
overlithiation techniques of the positive electrode.

Concerning the prelithiation techniques of the negative electrode, mention can be made of:
so-called “in situ” techniques consisting in depositing onto the negative electrode lithium metal (i.e. “0” degree of oxidation) either in the form of a metal sheet (as described in WO 1997031401) or in the form of a metal lithium powder stabilised by a protective layer (as described in Electrochemistry Communications 13 (2011) 664-667) mixed with the ink comprising the ingredients of the negative electrode (namely, the active material, the electronic conductors and an organic binder), with the lithium insertion taking place, independently of the alternative retained, spontaneously by a corrosion phenomenon;
the so-called “ex situ” techniques consisting in electrochemically prelithiating the negative electrode, by placing the latter in a set-up comprising an electrolytic bath and a counter-electrode comprising lithium, these techniques make it possible to control the quantity of lithium introduced into the negative electrode but however have the disadvantage of requiring the implementation of a complex experimental set-up.

Alternatively, it has also been proposed, in prior art, techniques for overlithiation of the positive electrode, in particular, by adding in the composition comprising the ingredients that constitute the positive electrode, a sacrificial salt which, during the first charge, will be decomposed and provide the required quantity of Li in order to form the passivation layer on the surface of the negative electrode.

In these techniques, note that the sacrificial salt must be able to decompose at a potential located in the potential window that sweeps the positive electrode during the first charge.

Also, when the first charge takes place, two simultaneous electrochemical reactions generate Li⁺ ions, which are the disinsertion of lithium from the positive electrode and the decomposition of the sacrificial salt. During the decomposition of the sacrificial salt, gaseous by-products are in particular formed, which will be removed at the end of the charging step. Indeed, unnecessarily increasing the burden on the accumulator by these by-products is as such prevented, which, furthermore, could disturb the later electrochemical operation of the cell.

These techniques are in particular described in document FR 2 961 634, which state that the sacrificial salt is introduced directly into the ink comprising the ingredients of the positive electrode, namely the active material, the electronic conductor, the organic binder, with the ink then being deposited onto a current collector substrate to form the positive electrode, whereby the sacrificial salt is distributed, randomly, in the positive electrode.

During the charging, the sacrificial salt is decomposed in order to form, in particular, gases, with the decomposition being at the origin of the creation of a porosity in the positive electrode, a variation of a few percentage points of the porosity that can generate a significant increase in the internal resistance, which is detrimental for the service life of the element. Also, knowing that the minimum porosity of an electrode is limited by the mechanical stress that it in turn has to support during the manufacture thereof (in particular, during a step of calendering), it is possible to be, after the first charge generating the decomposition of the salt, in ranges of porosity that are unfavourable for the operation of the accumulator.

For example, for a positive electrode comprising, as an active material, LiFePO₄, and 5% by weight of lithium oxalate and having a porosity of 35%, after cycling at 5 V with a negative electrode comprising, as an active material, a silicon/graphite composite, this results in an increase in the resistance, which has a value equivalent to that of an electrode having a porosity of 42%. This can be explained by the elimination in gases of the initial 5% of lithium oxalate, which occupy a volume of 7% of the electrode due to the density of 2.2 g/cm³ for the salt compared to 3.2 g/cm³ pour the electrode on the average.

In sum, these techniques have a certain number of disadvantages, as the decomposition of the sacrificial salt can generate several phenomena:
the appearance of dead volumes at the core of the electrode, due to the decomposition of the salt, which contributes to the increase in the porosity of the electrode; and
the electronic disconnection of certain portions of the electrode making the active material unable to be used and inducing, as such, a loss in the capacity of the accumulator.

Also, in light of the above, the authors of this invention have set as an objective to develop a method for manufacturing an accumulator of the lithium-ion type that makes it possible to overcome the aforementioned disadvantages and which makes it possible, in particular, to increase the capacity of the lithium-ion accumulator and therefore its energy density and also the cyclability of the accumulator.

### DISCLOSURE OF THE INVENTION

As such, the invention relates to a method for preparing a lithium-ion accumulator comprising a positive electrode and a negative electrode arranged on either side of an electrolyte, said positive electrode comprising, as an active material, a lithium based material, said method comprising the following steps:

a) a step of deposition on the surface of the positive electrode, before placing in the accumulator, of a lithium salt;

b) a step of assembling the positive electrode, the negative electrode and the electrolyte; and

c) a step of forming a passivation layer on the surface of the negative electrode with the lithium ions coming from the decomposition of the lithium salt by application of a first charge to the abovementioned assembly.

In other terms, the first charge is applied in the conditions of potential required for the decomposition of the lithium salt, this decomposition resulting in a release of lithium ions, which will contribute to the formation of the passivation layer on the surface of the negative electrode. Due to the fact that the lithium salt provides the lithium ions required for the formation of the passivation layer, this salt can as such be qualified as a “sacrificial salt”.

Also, the lithium ions required for the formation of the passivation layer do not come from the active material of the positive electrode. The lithium ions of the active material of the positive electrode are therefore not lost for the formation of this layer during the first charge and therefore the loss in the capacity of the accumulator is lesser and even zero.

Finally, applying a lithium salt on the surface of the positive electrode contrary to prior art, where the lithium salt is added to the precursor composition of the positive electrode, fulfils a certain number of advantages.

Indeed, on the one hand, at the end of the first charge, the layer comprising the lithium salt has entirely decomposed to provide the Li⁺ ions required for the formation of the passivation layer on the negative electrode, without this disorganising the internal structure of the positive electrode, with the latter, at the end of the first charge, having a structural organisation similar to that of a conventional electrode, in particular without there being any appearance of dead volume and loss of active material. As the lithium salt is on the surface of the electrode, there is no modification in the intrinsic porosity of the electrode.

On the other hand, contrary to the embodiments of prior art, wherein the sacrificial salt is introduced directly into the precursor composition of the positive electrode and where it is necessary to include a quantity of salt greater than that required for the formation of the passivation layer due to the impossibility of controlling the placing of the grains of salt in the structure of the electrode, the method of the invention gives the possibility of using, due to the location of the lithium salt immediately on the surface of the positive electrode, only the quantity sufficient for the formation of the passivation layer on the negative electrode. In this case, there is therefore no excess salt in the positive electrode after formation of the passivation layer and therefore any unnecessary matter in the latter.

As mentioned hereinabove, the method of the invention comprises a step of treating the positive electrode, before placing in an assembly comprising the negative electrode and the electrolyte, with this treatment consisting in depositing on the positive electrode (advantageously, at least on the face intended to be in contact with the electrolyte) a lithium salt, which is intended to participate in the formation of the passivation layer during the first charge of the assembly.

This step of deposition can be carried out, in particular, by an ink-jet technique, consisting in spraying onto the positive electrode, a composition comprising the lithium salt, said composition being able to be sprayed from a nozzle.

This step of deposition can also be carried out by coating with a composition comprising the lithium salt on the surface of the positive electrode.

In particular, the step of deposition can be carried out with a composition comprising:
the lithium salt;
an electrically-conductive carbon additive, such as carbon black;
a polymeric binder, such as a binder with a fluorinated polymer base such as polyvinylidene fluoride; and
an organic solvent, for example, an aprotic polar solvent, such as an N-methyl-2-pyrrolidone (NMP) solvent.

The lithium salt advantageously has an oxidisable anion with a lithium cation.

By way of example of lithium salt, mention can be made of the salts belonging to the following categories:
lithium azides of formulas N₃A, with A corresponding to a lithium cation;
lithium ketocarboxylates, such as those having the following formulas (II) to (IV):

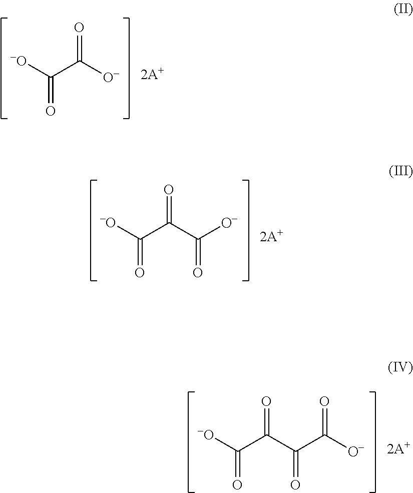

with A corresponding to a lithium cation;
lithium hydrazides, such as those having the following formulas (V) to (VI):

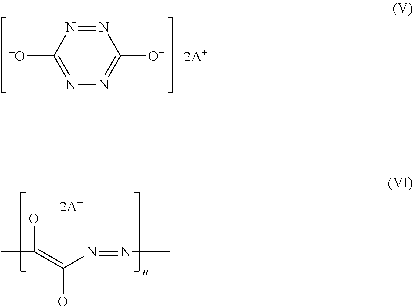

with A corresponding to a lithium cation and n corresponding to the repetition number of the pattern taken between brackets, with this repetition number able to range from 3 to 1000.

Advantageously, this can be a lithium salt of formula (II), which corresponds to lithium oxalate.

The positive electrode, whereon the lithium salt is deposited, comprises, as an active material, a lithium based material, said material fulfils the function of insertion material of the lithium and this, reversibly so that the processes of charging and discharging can take place during the operation of the accumulator.

Indeed, by positive electrode, it is stated, conventionally, in the above and in what follows, that it is the electrode that acts as a cathode, when the generator delivers current (i.e. when it is in the process of discharging) and acts as an anode when the generator is in the process of charging.

The active material of the positive electrode can be a material of the lithiated oxide type comprising at least one transition metal element or of the lithiated phosphate type comprising at least one transition metal element.

As examples of lithiated oxide compounds comprising at least one transition metal element, mention can be made of simple oxides or mixed oxides (i.e. oxides comprising several separate transition metal elements) comprising at least one transition metal element, such as oxides comprising nickel, cobalt, manganese and/or aluminium (with these oxides able to be mixed oxides).

More specifically, as mixed oxides comprising nickel, cobalt, manganese and/or aluminium, mention can be made of the following compounds of formula (VII):

LiM²O₂ (VII)

wherein M² is an element chosen from Ni, Co, Mn, Al and mixtures thereof.

By way of examples of such oxides, mention can be made of the lithiated oxides LiCoO₂, LiNiO₂ and the mixed oxides Li(Ni,Co,Mn)O₂ (such as Li(Ni_{1/3}Mn_{1/3}Co_{1/3})O₂) also known under the name NMC), oxides rich in lithium Li₁₊ₓ(Ni,Co,Mn)O₂, Li(Ni,Co,Al)O₂ (such as Li(Ni_{0.8}CO_{0.15}Al_{0.05})O₂ also known under the name NCA) or Li(Ni,Co,Mn,Al)O₂.

As examples of lithiated phosphate compounds comprising at least one transition metal element, mention can be made of the compounds of formula LiM¹PO₄, where M¹ is chosen from Fe, Mn, Co and mixtures thereof, such as LiFePO₄.

In addition to the presence of an active material, such as those defined hereinabove, the positive electrode can include a polymeric binder, such as polyvinylidene fluoride (PVDF), a carboxymethylcellulose mixture with a latex of the styrene and/or butadiene type as well as one or several electrically conductive adjuvants, which can be carbon materials such as carbon black.

As such, from a structural standpoint, the positive electrode can have the form of a composite material comprising a matrix with polymeric binder(s), in which are dispersed charges constituted by the active material and possibly the electrically conductive adjuvants, said composite material able to be deposited on a current collector.

Once the positive electrode treated by a lithium salt, it is assembled with a negative electrode and the electrolyte in such a way as to form the electrochemical cell of the lithium-ion accumulator.

It is stated here that the term negative electrode means, conventionally, in the above and in what follows, the electrode which acts as an anode, when the generator is delivering current (i.e. when it is in the process of discharging) and which acts as a cathode, when the generator is in the process of charging.

Conventionally, the negative electrode comprises, as an active electrode material, a material able to insert, reversibly, lithium.

In particular, the negative electrode active material can be:
a carbon material, such as hard carbon, natural or artificial graphite;
lithium metal or a lithium alloy, such as a silicon-lithium alloy, a tin-lithium alloy); or
a mixed lithium oxide, such as Li₄Ti₅O₁₂ or LiTiO₂.

Furthermore, in the same way as for the positive electrode, in particular when it is not made of metal lithium or a lithium alloy, the negative electrode can include a polymeric binder, such as polyvinylidene fluoride (PVDF), a carboxymethylcellulose mixture with a latex of the styrene and/or butadiene type as well as one or several electrically conductive adjuvants, which can be carbon materials, such as carbon black. What is more, as with the positive electrode, the negative electrode can have, from a structural standpoint, as a composite material comprising a matrix with polymeric binder(s), in which are dispersed charges constituted by the active material (having, for example, in the particulate form) and possibly the electrically conductive adjuvant or adjuvants, said composite material able to be deposited on a current collector.

The electrolyte, arranged between the positive electrode and the negative electrode, is a lithium ion conductive electrolyte, and can be, in particular:
a liquid electrolyte comprising a lithium salt dissolved in at least one organic solvent, such as an aprotic apolar solvent;
an ionic liquid; or
a solid polymer electrolyte.

By way of examples of lithium salt, mention can be made of LiClO₄, LiAsF₆, LiPF₆, LiBF₄, LiRfSO₃, LiCH₃SO₃, LiN(RfSO₂)₂, Rf being chosen from F or a perfluoroalkyl group comprising from 1 to 8 carbon atoms, lithium trifluoromethanesulfonylimide (known under the abbreviation LiTfSI), lithium bis(oxalato)borate (known under the abbreviation LiBOB), lithium bis(perfluorethylsulfonyl) imide (also known under the abbreviation LiBETI), lithium fluoroalkylphosphate (known under the abbreviation LiFAP).

By way of examples of organic solvents that can be used in the constitution of the aforementioned electrolyte, mention can be made of carbonate solvents, such as cyclic carbonate solvents, linear carbonate solvents and mixtures thereof.

By way of examples of cyclic carbonate solvents, mention can be made of ethylene carbonate (symbolised by the abbreviation EC), propylene carbonate (symbolised by the abbreviation PC).

By way of examples of linear carbonate solvents, mention can be made of dimethyl carbonate, diethyl carbonate (symbolised by the abbreviation DEC), dimethyl carbonate (symbolised by the abbreviation DMC), ethylmethyl carbonate (symbolised by the abbreviation EMC).

Furthermore, the electrolyte can be brought to soak a separator element, by a porous polymeric separator element, arranged between the two electrodes of the accumulator.

The assembly obtained as such is then subjected, in accordance with the invention, to a step of first charging in conditions of potential required for the decomposition of the lithium salt deposited on the surface of the positive electrode, with the decomposition being materialised by the release of the lithium ions, which will participate in the formation of the passivation layer.

Also, from a practical standpoint, it is understood that the lithium salt has to be able to decompose within a window of potentials that will sweep the positive electrode during the first charge.

As such, during the implementing of the first charge, other than the fact that the accumulator is charging, this also results in a decomposition reaction of the lithium salt. During this reaction, the lithium salt produces, furthermore, lithium ions which pass into the electrolyte and react with the latter to form the passivation layer on particles of active material of the negative electrode.

In addition to the release of lithium ions, the decomposition of the salt results in the production of a small quantity of gaseous compounds. The latter can be soluble in the electrolyte and can, if needed, be removed during a step of degassing.

Other characteristics and advantages of the invention shall appear in the following complement of the description and which refers to particular embodiments.

Of course, this complement of the description is provided solely as an illustration of the invention and does not form in any way a limitation of it.

### BRIEF DESCRIPTION OF THE DRAWINGS

FIG. 1 is a curve showing the change in the discharging capacity C (in Ah) according to the number of cycles N for the first accumulator and the second accumulator of the example 2.

### DETAILED DESCRIPTION OF PARTICULAR EMBODIMENTS

### Example 1

This example shows the preparation of a lithium-ion accumulator in accordance with the invention (referred to as the first accumulator), of which the positive electrode is coated beforehand with a layer comprising a lithium salt and an accumulator that is not in accordance with the invention (referred to as the second accumulator).

For this first accumulator, the positive electrode is obtained, by coating, on a current collector made of aluminium 1085 with a thickness of 20 μm, an ink comprising 90% by weight of LiFePO₄, 5% by weight of an electronic conductor of the carbon black type (Super P TIMCAL) and 5% by weight of a polymeric binder of the polyvinylidene fluoride type (obtained from the supplier Solvay) dispersed in NMP.

The coated electrode then passes in a drying oven, which allows for the evaporation of the solvent. A layer with a thickness of 140 μm and 19 mg/cm² is obtained on the collector.

The positive electrode is then treated, by depositing on the face intended to be in contact with the electrolyte, an ink comprising 87% by weight of lithium oxalate (obtained from the supplier Aldrich), 10% by weight of an electronic conductor of the carbon black type (Super P Timcal) and 3% by weight of a polymeric binder of the polyvinylidene fluoride type (solubilised in NMP), whereby 1.8 mg/cm² of lithium oxalate are deposited, then dried in order to evaporate the solvent.

The product is cut into pastilles with a diameter of 14 mm, which as such form circular electrodes. These electrodes are then calendered using a press so as to reduce the porosity of them and obtain a porosity of about 35%.

Once the positive electrode is treated as such, it is placed with a negative electrode formed from metal lithium on either side of a polypropylene separator 25 μm thick (Celgard 2500) soaked with an electrolyte comprising a mixture of carbonate solvents (ethylene carbonate/dimethyl carbonate/ethyl and methyl carbonate in volume proportions 1:1:1) with a lithium salt LiPF₆ (1 mol/L), whereby an electrochemical cell results of the CR2032 button accumulator type.

For the second accumulator, the latter is prepared, similarly, at the first accumulator, if only that the positive electrode does not undergo a surface treatment with an ink comprising lithium oxalate.

The first accumulator and the second accumulator are subjected to an electrical formation at a rate of C/10 corresponding to a charge in 10 hours.

At the end of the first charge up to 5 V, the capacity of the first accumulator is estimated to be 5.3 mAh, while the capacity of the second accumulator is estimated to be 4.6 mAh, with the difference of 0.7 mAh able to be attributed to the oxidation of the lithium oxalate of the layer deposited on the surface of the electrode, releasing additional lithium ions.

### Example 2

This example shows the preparation of a lithium-ion accumulator in accordance with the invention (referred to as the first accumulator), of which the positive electrode is coated beforehand with a layer comprising a lithium salt and an accumulator that is not in accordance with the invention (referred to as the second accumulator).

The preparation of the accumulators is similar to that presented in example 1, if only that the negative electrode, whether for the first accumulator or for the second accumulator, is an electrode comprising, as an active material, graphite.

This electrode is coated, conventionally, by transfer using an ink comprising 96% by mass of active material (Timcal SLP30), 2% of carboxymethylcellulose (Aldrich) and 2% of styrene butadiene latex (BASF) dispersed in deionised water.

The first accumulator and the second accumulator are subjected to an electrical formation at a rate of C/10 between 2.5 and 5V, in such a way as to measure the capacity at the end of the first charge and the discharge capacity after this first charge.

At the end of the first charge up to 5 V, the capacity of the first accumulator is estimated to be 5.3 mAh, while the capacity of the second accumulator is estimated to be 5 mAh while the discharged capacity is estimated to be 3.9 mAh for the first accumulator and 3.6 mAh for the second accumulator, which corresponds to a gain of 8% thanks to the addition of the layer comprising lithium oxalate.

A test is also conducted consisting in subjecting the first accumulator and the second accumulator to a cycling comprising 50 charge-discharge cycles at a rate of C/2 between 2 and 3.6 V at ambient temperature.

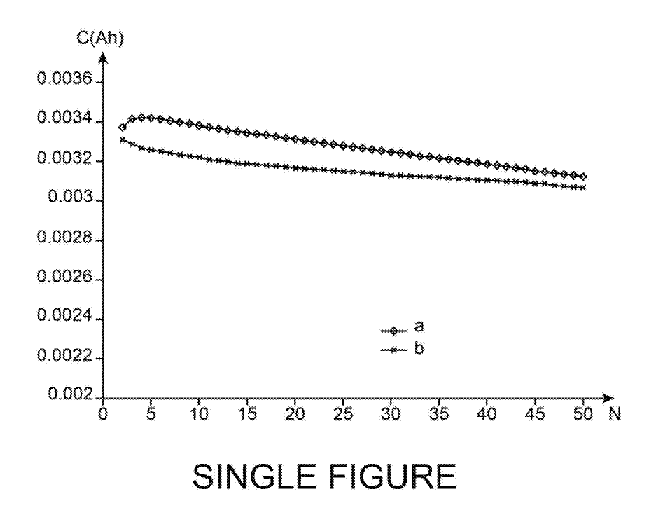

At the end of each cycle, the discharge capacity of the accumulators (expressed in Ah) is measured, with the values of the capacity reported in FIG. 1, showing the change in the discharge capacity C (in Ah) according to the number of cycles N, with the results for the first accumulator and the second accumulator being respectively shown by curves a) and b).

This results, from FIG. 1, that the first accumulator has the best results. This can be explained by the fact that, during the first charge, the passivation layer is formed using lithium ions coming from the decomposition of the lithium salt added on the surface of the electrode and not lithium ions coming from the active material and/or from the core of the material of the electrode.

What is claimed is:

1. Method for preparing a lithium-ion accumulator comprising a positive electrode and a negative electrode arranged on either side of an electrolyte, said positive electrode comprising, as an active material, a lithium based material, said method comprising the following steps:
a) a step of deposition on the surface of the positive electrode, before placing in the accumulator, of a lithium salt;
b) a step of assembling the positive electrode, the negative electrode and the electrolyte; and
c) a step of forming a passivation layer on the surface of the negative electrode with the lithium ions coming from the decomposition of the lithium salt by application of a first charge to the abovementioned assembly.

2. Method according to claim 1, wherein the step of deposition is carried out via an ink-jet technique, consisting in depositing on the positive electrode, a composition comprising the lithium salt.

3. Method according to claim 1, wherein the lithium salt is deposited via a composition comprising:
the lithium salt;
an electrically-conductive carbon additive;
a polymeric binder; and
an organic solvent.

4. Method according to claim 1, wherein the lithium salt is chosen from:
the lithium azides of formula N₃A, with A corresponding to a lithium cation;
lithium ketocarboxylates, such as those having the following formulas (II) to (IV): 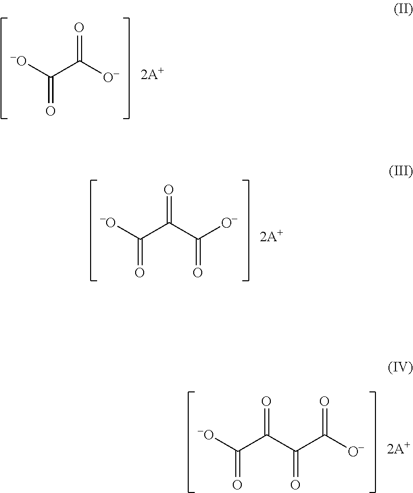
with A corresponding to a lithium cation;
lithium hydrazides, such as those having the following formulas (V) to (VI): 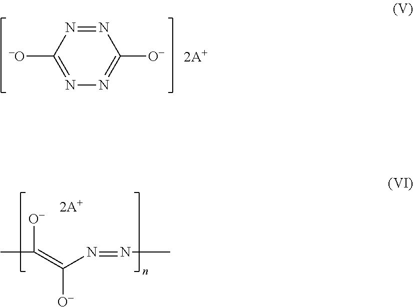
with A corresponding to a lithium cation and n corresponding to the repetition number of the pattern taken between brackets, with this repetition number able to range from 3 to 1000.

5. Method as claimed according to claim 1, wherein the lithium salt is the lithium ketocarboxylate of formula (II), also called lithium oxalate.

6. Method as claimed according to claim 1, wherein the positive electrode comprises, as an active material, a material of the lithiated oxide type or of the lithiated phosphate type comprising at least one transition metal element.

7. Method as claimed according to claim 1, wherein the positive electrode comprises, as an active material, LiFePO₄.

8. Method according to claim 1, wherein the negative electrode comprises, as an active material:
a carbon material, such as hard carbon, graphite;
lithium metal or a lithium alloy, such as a silicon-lithium alloy, a tin-lithium alloy; or
a mixed lithium oxide, such as Li₄Ti₅O₁₂ or LiTiO₂.

9. Method according to claim 1, wherein the negative electrode comprises, as an active material, graphite.
